(19) United States
(12) Patent Application Publication
(10) Pub. No.: US 2009/0040043 A1
(43) Pub. Date: Feb. 12, 2009

(54) Position Tracking Device for an Object and Control Procedure

(75) Inventors: Joachim Rohr, Hamburg (DE); Juergen Unruh, Hochheim (DE)

Correspondence Address: FISH & RICHARDSON PC, P.O. BOX 1022, MINNEAPOLIS, MN, 55440-1022, US

(73) Assignee: Lufthansa Systems AG

(21) Appl. No.: 12/178,955

(22) Filed: Jul. 24, 2008

(30) Foreign Application Priority Data
Aug. 3, 2007 (EP) 07 015 311.9

(51) Int. Cl. G08B 1/08; G08B 13/00

(52) U.S. Cl. 340/539.13; 340/572.3

(57) ABSTRACT

A device for the tracking of an object is presented. The device comprising a wireless communication unit for the transmission of data via a wireless communications network, a measuring device, and a controller, wherein the wireless communication unit is controlled via the controller and wherein the measuring device is connected to the controller. The invention provides based on the measuring device the detection of a first transportation status, in which the device is located inside an aircraft or is in the state of flight. The detection of the transportation status of the device by the measuring device in an aircraft or in flight offers the opportunity to control other features of the device, in particular in regard to the wireless communication unit, in such manner as not to interfere with the electronic controls of an aircraft.

### CROSS REFERENCE TO RELATED APPLICATIONS

Under 35 U.S.C. § 119, this application claims priority to European Patent Application No. EP 07 015 311.9, filed Aug. 3, 2007, the contents of which are hereby incorporated by reference in its entirety.

### TECHNICAL FIELD

This disclosure relates to a a position tracking apparatus for an object and control methods.

### BACKGROUND

In some positioning systems for motor vehicles, based on a Global System for Mobile communications (GSM) wireless communication unit, a position determined by a global positioning system (GPS) receiver, for example, is transmitted to a remote station, e.g. a central data analysis facility. Such devices are used to track the positions and movements of individual vehicles or fleets of vehicles. In these cases, the tracking devices consider the entire vehicle a moving object.

### SUMMARY

In some embodiments, the disclosure provides a device for the tracking of an object, which independently and universally accommodates the safety requirements of air traffic in regard to the emission of electromagnetic radiation.

In some embodiments, this disclosure provides a device for the tracking of an object, including a wireless communication unit for the transmission of data via a wireless network, a measuring device, and a controller, wherein the wireless communication unit is controlled via the controller, and wherein the measuring device is connected to the controller, characterized by use of a measuring device in order to detect a first transportation status of the device, in which the device is located inside an aircraft or in flight. The detection of the transportation status of the device by the measuring device in an aircraft or in flight offers the opportunity to control other features of the device, in particular in regard to the wireless communication unit, in such manner as not to interfere with the electronic controls of an aircraft. When the absence of the first transportation status is detected with sufficient confidence, the wireless communication unit will be activated based on potential additional criteria, and a set of data will be sent to a data processing facility. These data may contain a determined position of the device and a corresponding individual identifier.

In a preferred advanced design, the wireless communication unit is deactivated when the first transportation state is detected, so that in the first transportation state no radio signals or electromagnetic waves are emitted by the wireless communication unit. Alternatively or in addition, it may be provided that—depending on the applicable safety regulations—the detection of the first transportation state or similar measures may result in a reduction of the transmitting power of the wireless communication unit.

In the interest of the versatility of the inventive device, the wireless communication unit, the measuring device and the controller are configured in the form of a single module, allowing variable, module-type use on different tracking objects, as needed. In an especially preferred embodiment, the module exhibits an independent power supply like an aviation-approved rechargeable battery, a non-rechargeable battery, or a fuel cell. Advisably, the option of an external power supply is provided as well. Expediently, the external power supply will automatically charge a battery integrated into the module or keep it charged.

In a particularly preferred embodiment, the measuring device exhibits a sensor suitable to measure altitudes, e.g. an air pressure sensor. One possible criterion for the detection of the first transportation status may be that an altitude measured via air pressure shall not exceed a specific limit, like 4,000 meters (about 13,000 ft.), for example.

Alternatively or in addition, the measuring device may exhibit a motion detector. A motion detector will, due to the continuous movements and vibrations created by the in-flight status, generate a signal indicating that the device is in motion.

Furthermore, alternatively or in addition, the measuring device may exhibit at least one, in particular, at least two vibration sensors. A criterion for the first transportation state may a vibration signal detected by the sensors.

In an alternative or additional embodiment, the measuring device may exhibit an ultrasound sensor. In particular, in an embodiment, in which the device is installed in the vicinity of an operating aircraft engine, the ultrasound sensor will be able to transmit reliable data about the operating state of the engine. The presence of a sufficiently strong ultrasound source will generally indicate that the engine is operating, whereupon the wireless communication unit will be deactivated.

In a particularly preferred embodiment, the measuring device exhibits a receiver for signals from a global positioning system (GPS). Advantageously, the signal strength of the global positioning system can be determined via the measuring device, whereby the signal strength is used—at least optionally—to detect the first transportation status. This is based on the observation that the strength of a signal emitted by a GPS satellite is in a typical manner attenuated inside the fuselage/hull of a cargo plane, e.g. by about 20 decibel. Purposefully, the strength of the signal received from a single or multiple satellites will be averaged across a sufficient time period, e.g. 30 seconds, and the calculated signal strength will be compared to a threshold value. A sufficiently low calculated signal strength is a relatively reliable indication that the device in located inside a cargo plane, in particular with a closed loading hatch. In order to optimize logistics associated with the tracking of the object's route of transportation, it is sufficient to check its position once a day. It may therefore be assumed to a far extent that the wireless communication unit of the device will also be deactivated when stored in an unfavorable position outside an aircraft, in a strongly shielding warehouse, for example.

Through the use of a global positioning system, the global positioning system obtains information—in particular the momentary position and/or the speed—in an especially advantageous manner. In a preferred embodiment, the obtained position and/or the speed can be forwarded by the wireless communication unit, resulting in an especially accurate tracking of the device. The transmitted information may also be an additional criterion for the verification of the first transportation status, e.g. by comparing the measured speed with a threshold value, e.g. 120/h (74.5 mph). Any speed above this threshold value reliably indicates that the object is in flight.

In an additional preferred embodiment, the measuring device provides an additional transportation status, wherein the object is in motion throughout the transportation, but is not inside an aircraft. For example, in this additional state of transportation the object may be located on a truck. Since in this case, there are no safety concerns regarding the sending of data via the wireless communication unit, such transportation status should be differentiated from the aircraft status. A possible criterion may be the continued presence of a sufficiently low speed (measured by GPS) in conjunction with a higher GPS signal strength than can usually be received inside the fuselage of an aircraft.

Furthermore, alternatively or in addition, the measuring device may provide differentiation of one additional transportation status, in which the object is not located inside an aircraft, and is not in motion. In this transportation state, the object is located inside a warehouse, on an airfield, or is in an otherwise at least temporarily stationary position. At least in this state of transportation which—due to a strong GPS signal—can be determined especially well, the absence of vibration, absence of motion as determined by the GPS, or similar parameters, the wireless communication unit can be activated with subsequent transmission of data about the position and the status of the tracked object.

For improved confidence it may be advantageous for the absence of the first transportation status to be confirmed only if at least two signals independent from each other indicate the absence of the first transportation status. This prevents the inadmissible activation of the wireless communication unit due to a wrong decision especially effectively. The two independent signals are advantageously selected from the group of GPS signal strength, GPS-determined speed, vibration and air pressure. For example, it may be provided that the wireless communication unit will be activated by the logic of the controller only if the GPS signal strength is above a specific threshold value, and the GPS-determined speed is below a specific threshold value. Expediently, it may also be provided that none or only sufficiently small vibrations are measurable while the air pressure must be above a specific threshold value.

Generally preferred, the wireless communication unit operates according to the GSM standard for wireless communication networks. The GSM standard is used worldwide, so that a device according to the invention can be utilized in an especially universal manner. The data can be transmitted easily by Short Message Service (SMS) or General Packet Radio Service (GPRS) protocols or other suitable standardized, and especially, commonly used protocols.

The invention also pertains to cargo being transported by aircraft, whereby a device is installed on the cargo. In this case, the cargo is the object to be tracked with the device. Especially advantageously, the cargo will be a ULD container (ULD=United Load Device). This type of standardized air freight container is used for the shipping of randomly shaped cargo in aircraft.

In a particularly preferred embodiment, the cargo is an engine shipping cradle. Aircraft engines are commonly serviced and overhauled at centralized, special service centers, and afterwards shipped to different places of the world, especially by air cargo. This process utilizes special shipping cradles, which are complex structures of inherent high value.

Aircraft engines are an especially valuable cargo, which is notably continuously in motion, either due to shipment inside an engine shipping cradle or when utilized for aircraft propulsion. The close position tracking, especially of aircraft engines, is in any case desirable in order to optimize logistics. The logistical goals are minimum waiting times and as few as possible loss and search operations.

The invention advantageously also includes an engine for an aircraft, on which a device is installed. Such engine according to the invention may be utilized as active propulsion unit of an aircraft, whereby the device is usually securely mounted inside the engine. This type of tracking is especially desired and useful for leased engines. In this case, there might be situations, where the lack of information from leasing customers can lead to significant additional expenses. Occasionally, there are also return requests for leased engines, which may be difficult to locate and therefore require extra effort and expenses. In such cases, the device according to the invention can report the momentary location of the leased engine, and generally allow a complete tracking of the operating status of the leased engine.

The device may be powered the engine, whereby expediently a battery at the device is also provided allowing the transmission of status information via the wireless communication unit when the engine is shut off. It may also be provided that the device can be activated only when the engine's power supply is on.

Generally, the first status of transportation is present when the engine is in operation, at least, however, when the engine has reached a specific number of rotations per minute, or when the aircraft is in flight. If the device according to the invention is installed on an engine that is in operation, the power supply of the engine may be an especially reliable parameter for the deactivation of the wireless communication unit, for example. Furthermore provided in this embodiment may be an ultrasound sensor since engines in operation always generate strong sound waves in the ultrasound range. A single, or for reliability, two vibration sensors might be provided to verify the operation of the engine via the measuring device. This ensures that the wireless communication unit does not send any signals when the engine is in the first state of transportation or in operation.

In a preferred detailed design of a device according to the invention installed on an operating engine, a GPS receiver is effectively unnecessary. In this case, the device and/or the engine can easily be located via the identifier of the remote station connected to the wireless communication unit. Depending on how this detail is engineered, this method of localization may be more or less precise. Devices attached to engines will regularly communicate from the location of an airport with a central office, so that the accuracy of the location via the identifier of the momentary base station is always sufficient. Other advantages of the optional dispensing of a GPS receiver result from higher reliability and lower cost due to less engineering expenses.

The invention also provides also a control procedure for a device. It generally includes the obtainment of a first measuring value which is then compared to a predefined first threshold value. The wireless communication unit is then activated based on the results of the comparison, so that for safety reasons the wireless communication unit will not be activated when the comparison of the first measuring value with the predefined threshold value indicates with sufficient confidence that the device is in the first state of transportation.

The control procedure preferably includes a standard mode, in which the wireless communication unit is deactivated. In this standard mode the device, which may be operated by a battery, for example, will use very little energy.

Advantageously, the standard mode provides that after a defined time window has timed out, for example after several hours, the procedures of obtainment of a first measuring value, comparison of the first measuring value to a predefined first threshold value, and activation of the wireless communication unit based on the results of the comparison will be performed.

Alternatively or in addition it may be provided that the procedures of obtainment of a first measuring value, comparison of the first measuring value to a predefined first threshold value, and activation of the wireless communication unit based on the results of the comparison will be performed in response to a sensor signal, in particular a motion sensor signal. For example, the device may be in a standard mode, in which the wireless communication unit will not be activated for a longer period of time. A movement of the device would then generate a signal based on which prior to the expiration of the time window the momentary status of transportation will be determined by the measuring device and the procedures of obtainment of a first measuring value, comparison of the first measuring value to a predefined first threshold value, and activation of the wireless communication unit based on the results of the comparison, wherein—depending on the result—the wireless communication unit will be activated, and data will be sent to the remote station.

In a preferred embodiment, the value measured in obtaining a first measuring value is the strength of a GPS signal being received. For practical purposes, this is the strength/amplitude of the signal averaged over time, e.g. over 30 seconds, whereby the signals of several satellites may be averaged. The values are averaged so that the measured value provides useful information about the shield surrounding the GPS receiver, i.e. it will become quickly apparent that the device is stowed inside the fuselage of an aircraft with a closed hatch. Alternatively and in addition, the system detects the first state of transportation of the device when the signal strength of the GPS signal falls below a predefined threshold value or when the GPS signal does not allow the speed to be measured (especially due to a weak signal), or when the speed determined via the GPS signal is greater than a predefined threshold value. Every one of the named measuring results based on the GPS signal can be used to indicate with sufficient confidence the first state of transportation of the device is order to accordingly prevent the activation of the wireless communication unit.

In an preferred advanced embodiment of the invention, a second state of transportation, in which the wireless communication unit is activated, will be detected only when the speed determined by the GPS signal is below a predefined threshold value and the signal strength of the GPS signal is above a predefined threshold value. This second state of transportation identified in this manner may be present in particular when the device is located on a truck, whereby a truck—in contrast to an aircraft—is unable to reach speeds above said threshold value. Such suitable threshold value may be, for example, about 120 km/h (74.5 mph), since trucks often move at a speeds lower than this speed, and aircraft most often move at speeds faster than 120 km/h (74.5 mph). Furthermore, the cargo holds of trucks shield GPS signals in most cases less than the cargo holds of aircraft, so that the signal of the GPS signal in a truck will generally be stronger than in an aircraft.

Additionally provided may be a third state of transportation, in which the wireless communication is activated and detected only if the speed detected by the GPS signal is at least close to zero. This allows the user to differentiate if the device is located on a truck or in a warehouse. In particular, the measured speed may be an indication of the momentary speed over a period of several minutes. The differentiation between a second state of transportation (truck) and a third state of transportation (ground or warehouse) is practical because it can be used to transmit data via the wireless communication unit more often or less often. Especially when the tracked object is at a stationary position in a warehouse, it will be generally desirable to preserve the power source of the device and not to create unnecessary expenses, so that the wireless communication unit may send a status message every few hours or even only then, when the state of transportation based on the results of the measuring device changes. If, however, the device is located on a truck or is in motion, a more frequent data exchange with the device may be desirable in order to closely track the progress of the transport or to be able to quickly detect theft.

In a preferred advanced embodiment, activation of the wireless communication unit based on the results of a comparison of the first measuring value to a predefined first threshold value occurs only if the comparison indicates at least two times within the defined time period the absence of the first state of transportation. This provides a simple safeguard against any false activation of the wireless communication unit in an aircraft or in the state of flight. This will, for example, prevent even under unfavorable circumstances that the first state of transportation will be indicated even in the presence of a strong GPS signal in conjunction with a measured GPS speed of less than 120 km/h (74.5 mph).

Generally preferred, the device may be located via transmission of an identifier signal from an affiliated base station. This provides at least a rough localization of the device through the wireless network itself without the need for extensive measurements via GPS signals or other means. The device can also be located fairly accurately via the data of the connection of the wireless communication unit with the surrounding base stations, if so desired.

Furthermore preferred, the data measured by the measuring device will be continuously logged in the form of a data record. Such measuring data may include in particular information from the group of position, speed, air pressure, temperature, and vibration. The continuous logging of such in a log file and the according transmission of such log file to a central office via the wireless communication unit allows, if needed, the complete and unbroken tracking of the transportation and status history of the object, without the need for a continuous connection between the inventive device and a remote base station.

In a preferred advanced embodiment of the procedure it is provided that when the object leaves a predefined geographical area, the wireless communication unit will automatically send a corresponding message. This allows the definition of a “virtual fence” which, when crossed, creates a very real-time piece of information, especially at the next time the first state of transportation is absent.

Advantageously, the wireless communication unit transmits data in response to a request from a data center. This request may be sent, for example, via SMS in the form of a code to the wireless communication unit. This avoids the unnecessary transmission of information. Depending on the requirements it may alternatively or in addition be provided that the wireless communication unit transmits the data based on a predefined time schedule.

Additional advantages and features of the invention can be obtained from the embodiments described below as well as from the subclaims.

### DESCRIPTION OF DRAWINGS

Following is an explanation of two preferred embodiments of a device according to the invention based on the attached drawings.

FIG. 1 shows a schematic block diagram of a first embodiment of a device according to the invention.

FIG. 2 shows a schematic representation of the operation of the device in FIG. 1.

FIG. 3 shows a schematic block diagram of a second embodiment of a device according to the invention.

FIG. 4 shows a schematic representation of the operation of the device in FIG. 3.

### DETAILED DESCRIPTION

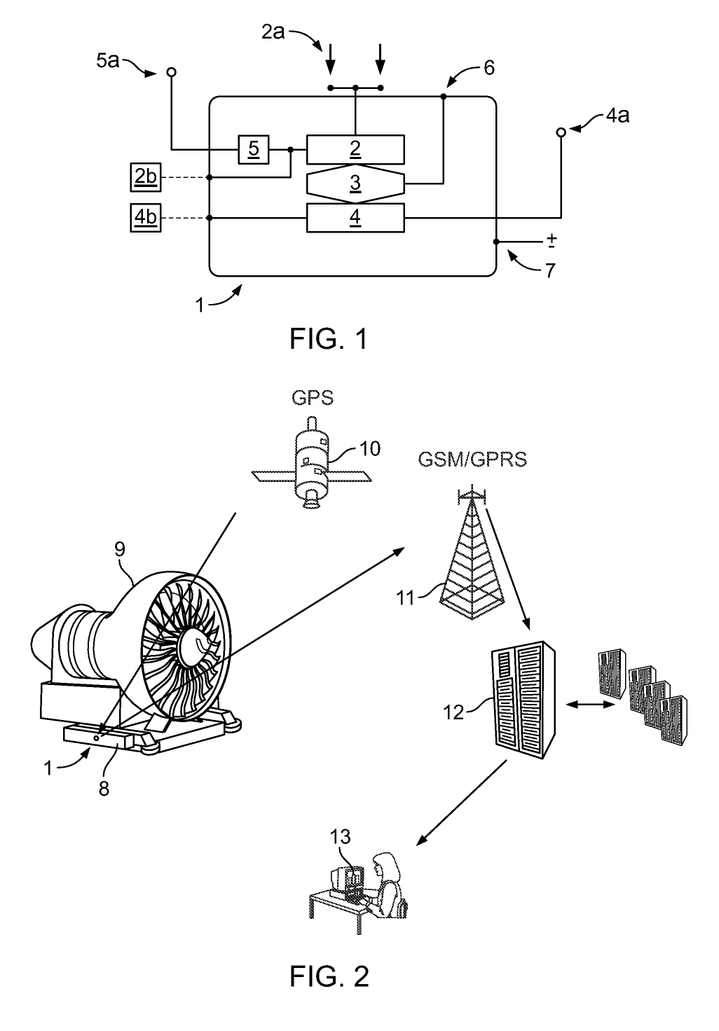

The first embodiment of a device according to the invention shown in FIG. 1 comprises a module 1 into which a measuring device 2, a controller 3, a wireless communication unit 4, and a GPS receiver 5 are integrated. “GPS” stands for “Global Positioning System” and indicates for the purpose of the invention generally comprehensive systems for the detection of a position. In the concrete embodiment, GPS indicates in particular the satellite-based NAVSTAR GPS operated by the US Department of Defense. The GPS receiver 5 includes an antenna 5a which, depending on the design, may be integrated into the module or connected externally.

In this case, the measuring device 2 is a data logging device, and connected to sensors via connectors 2a. The connections may be digital or analog.

One of the sensors connected to the measuring device 2 (not shown) is a motion sensor, which may be a vibration sensor, an acceleration sensor, a gyro compass, or a similar type of sensor.

The measuring device 2 is also connected to the GPS receiver 5 via a data line, so that from the system-analytical view, the GPS receiver may be interpreted as a sensor of the measuring device 2.

An additional data line 2b of the measuring device 2 is used for the optional connection of additional input devices via an interface, for example, an RS-232 interface. Such input device can be a barcode reader or similar device, for example.

The measuring device 2 is connected to the controller 3 via an interface like a data bus, for example. A control line 6 is connected directly to the controller 3 in order to allow the device to be remotely controlled, for example.

The wireless communication unit 4 is a GSM modem, and can be connected to worldwide wireless networks based on the GSM standard. The GSM modem is connected to the controller via an interface. This interface can be used to selectively activate and deactivate the wireless communication unit 4. The wireless communication unit 4 is connected to an antenna 4a and also exhibits a port 4b for the optional connection of a speaking device in order to use the GSM modem as mobile phone as may be required for maintenance purposes, for example.

Module 1 also exhibits a port 7 for the connection of an external power supply. Integrated module 1 is an aviation-approved, re-chargeable battery (not shown), which can be recharged via port 6. This allows module 1 to operate independently over a longer time period of several days or weeks. If the energy consumption is optimized by the control procedure of the device, the unit may operate for up to 4 months. These types of devices have large, aviation-approved rechargeable batteries with a total weight of about 9 kg (about 20 lbs.).

Due to the sometimes extreme conditions during flight transportation, the module is designed for the especially wide range of temperatures of −56° C. (−69° F.) to +80° C. (176° F.).

FIG. 2 shows a sample overview of a complete system with the device according to the invention. Module 1 is installed on an engine shipping cradle 8 with an engine 9 to be transported inside the cradle 8. Engines 9 are regularly shipped in such shipping cradles over long distances to be serviced. On one hand, the high value of the cargo is a logistical challenge, and especially in the case of engines, timely shipping and delivery schedules are of the essence.

Module 1 is used to track the position of the object 8, 9. It receives data from the GPS satellite system 10. The positioning data received and potentially any other obtained status data are transmitted via the connection of the wireless communication unit 4 of module 1 to a base station 11 by SMS or GPRS or other suitable data transmission protocols, and sent from there to a computer center 12. A user 13 can access this information from the computer center via an internet connection, for example. This can be done, for example, using a homepage in the World Wide Web. Depending on the requirements, known security measures (password, encrypted transmission) are provided.

In the following, a sample of a possible control procedure of the device is described and explained.

In order to save energy and as a rule, the device is in standard mode, in which the GPS receiver and the wireless communication unit are deactivated. The standard mode will be interrupted either by the expiration of a defined time window (typically several hours), or when the motion sensor indicates movement.

In the following, the first the state of transportation is determined whereby this embodiment differentiates between three states of transportation. The critical parameter is in each case the strength of the GPS signal received, indicated as “dbHz”, which generally indicates the signal-background ratio:

### 1. Transportation Status “Ground”

In the transportation status “Ground”, the wireless communication unit can be activated at module 1 and, if needed, data communication will be established via SMS or GPRS. The transportation status “Ground” is determined based on

the GPS signal image

the signal of the motion sensor, and

the GPS speed information.

Variation “Ground 1”:

Motion sensor sends a signal=1 (in motion)

=>GPS receiver will be activated

=>GPS Signal>=55 dbHz (otherwise cancel, potentially check for transportation status “Truck 2”)

=>Is measured speed=0-2 km/h? (1.3 mph)

=>YES

=>wireless communication unit activates

=>data communication is established

=>after transmission of the data, the wireless communication unit 4 and the GPS receiver 5 deactivate

=>device switches into standard mode.

Variation “Ground 2”:

Motion sensor sends a signal=0 (stationary position)

=>time window for self-activation has expired (YES)

=>GPS receiver activates

=>GPS signal>=55 dbHz (otherwise cancellation, potentially check for transportation status “Truck 2”)

=>is measured speed =0-2 km/h? (1.3 mph)

=>YES

=>wireless communication unit activates

=>data communication is established

=>after transmission of the data wireless communication unit 4 and GPS receiver 5 deactivate

=>device switches into standard mode.

### 2. Transportation Status “Truck”

In transportation status “Truck” the wireless communication unit at module 1 can be activated and a data communication can be established via SMS or GPRS.

The transportation status “Truck” is determined via

the GPS signal image

the signal of the motion sensor, and

the GPS speed information

Variation “Truck 1”:

Motion sensor sends a signal=1 (in motion)

=>GPS receiver activates

=>GPS signal>=55 dbHz (if not, check for variation “Truck 2”)

=>is measured speed<120 km/h (74.5 mph)?

=>YES

=>after 3 minutes

=>GPS signal>=55 dbHz

=>measure speed again<120 km/h?

=>YES

=>the wireless communication unit activates

=>data communication is established

=>after transmission of the data, the wireless communication unit and the GPS receiver deactivate

=>device switches into standard mode

=>NO (speed is greater than 120 km/h (74.5 mph))

=>GSM module does not activate (transportation status “Flight”)

=>Device switches into standard mode.

Variation “Truck 2”:

Motion sensor sends a signal=0 (stationary position)

=>time window for self-activation has expired (YES)

=>GPS receiver activates

=>GPS signal>=40 dbHz (reduced value)

=>is the measured speed<120 km/h (74.5 mph)?

=>YES

=>after 3 minutes

=>GPS signal>=55 dbHz

=>measure speed again<120 km/h (74.5 mph)?

YES

=>wireless communication unit activates

=>data communication is established

=>after transmission of the data the wireless communication unit and the GPS receiver deactivate

=>device switches into standard mode

−>NO (speed greater than 120 km/h (74.5 mph))

=>wireless communication unit does not activate (transportation status “Flight”)

=>device switches into standard mode.

### 3. Transportation Status “Flight”

In transportation status “Flight” the wireless communication unit of the device is not active, and no data communication is established via SMS or GPRS.

The transportation status “Flight” is determined based on

the GPS signal image

the signal of the motion sensor, and

the GPS speed information.

Variation “Flight 1”

Motion sensor sends a signal=1 (in motion)

=>GPS receiver activates

=>GPS signal<=40 dbHz (reduced value)

=>YES

=>after 3 minutes

=>GPS Signal<=40 dbHz (reduced value)

=>measure speed again>120 km/h (74.5 mph)?

=>YES

=>wireless communication unit does not activate (transportation status “Flight”)

=>Device switches into standard mode

=>NO (No GPS data available for calculation)

=>wireless communication unit does not activate (transportation status “Flight”)

=>Device switches into standard mode.

Variation “Flight 2”

Motion sensor sends a signal=0 (stationary position)

=>Time window for self-activation has expired (YES)

=>GPS receiver activates

=>GPS Signal<=40 dbHz (reduced value)

=>YES

=>is the measured speed>120 km/h (74.5 mph)?

=>YES

=>after 3 minutes

=>GPS signal<=40 dbHz (reduced value)

=>speed measurement>120 km/h (74.5 mph)?

=>YES

=>wireless communication unit does not activate (transportation status “Flight”)

=>Device switches into standard mode

=>NO

=>Device switches into standard mode

=>NO (No GPS data available for calculation)

=>Wireless communication unit does not activate (transportation status “Flight”)

=>Device switches into standard mode.

Overall, the steps of the control procedure ensure that the wireless communication unit cannot be activated inside an aircraft, thereby preventing any interference of the wireless radiation with the electronic controls of the aircraft. Twice the security is being achieved by the fact that two independent criteria must be met to verify the absence of the transportation status “Flight”, and therefore to potentially activate the wireless communication unit. The first criterion is a minimum signal strength of the GPS signal which is usually not typical for the inside of the cargo space of an aircraft. A second criterion for the absence of the flight status in the described embodiment is a value below a threshold speed, below which an aircraft is unable to fly (e.g. 120 km/h (74.5 mph)).

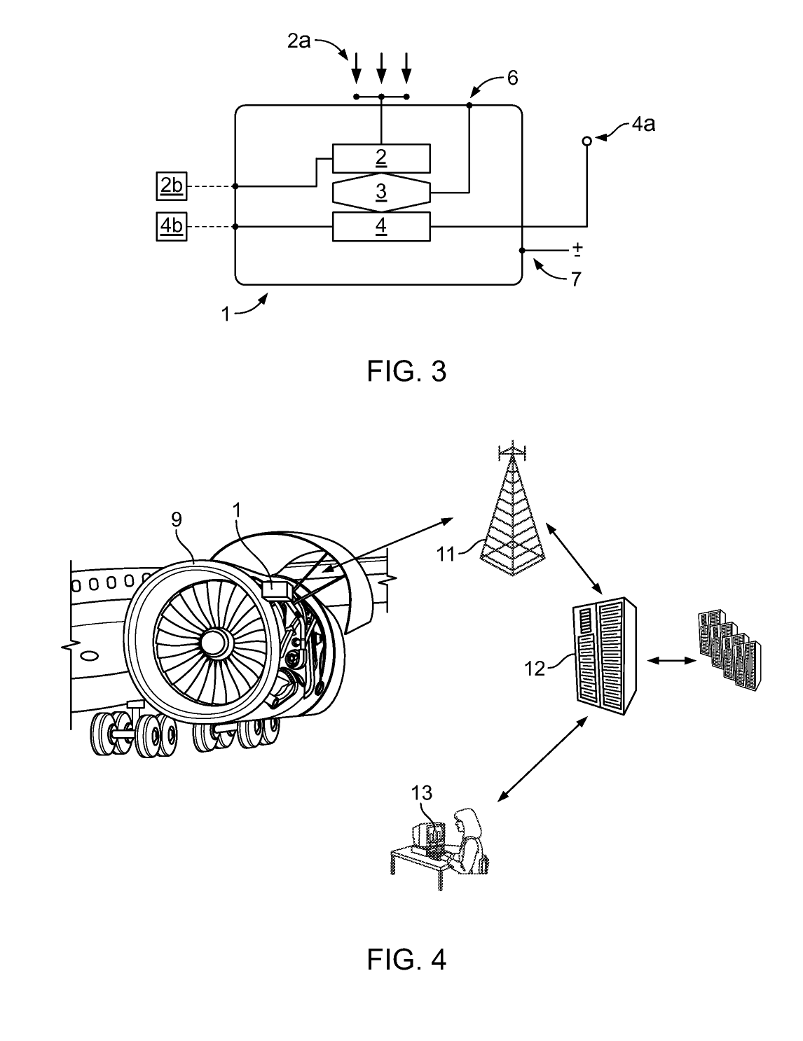

A schematic representation of a second preferred embodiment of the invention is shown in FIG. 3. This is a device, which has been optimized for installation at and/or use on operating engines. In contrast to the first embodiment, this device does not include a GPS receiver, as shown in FIG. 4. Instead of GPS positioning, the position of this device is determined via the wireless network only, to which the wireless communication unit logs on after determining that the first transportation status (flight status) is absent. Every base station of a wireless network has an MSC identifier (MSC=Mobile Switching Center) so that the position can be determined at least roughly via this identifier. In a known manner it is possible to perform very precise positioning calculations using the wireless network. At least in the case of assembled and operating engines, this type of precise positioning is usually not required because in order to locate the engines it is usually sufficient to match the base station ID to a specific airport.

Apart from the absence of a GPS receiver, the device of the second embodiment also includes a measuring device 2, a controller 3, and a wireless communication unit 4 with an antenna 4a, whereby these components are integrated into a module 1.

In order to decide if the first status of transportation is present, the device of the second embodiment has several sensors available, which are connected to the measuring device 2 at the connectors 2a. The sensors may also be installed inside or outside of module 1.

A first sensor and a second sensor as well are vibration sensors, whereby an engine in operation usually triggers the vibration sensor. Two sensors are provided for reasons of redundancy and thus for security.

An additional sensor is an ultrasound sensor. At least in the status of flight, the air close to the engine always generates a high ultrasound level, causing the ultrasound sensor to respond.

Another sensor is an air pressure or altitude sensor. This sensor can be used to determine the momentary flight altitude, so that even if the engine is shut off the flight status will still be detected.

Furthermore, one or several temperature sensors are provided, whose measuring values are at least during the flight continuously stored, so that important information about the operating status of the engine can be obtained.

Also provided is an “off-wing” sensor, which detects if the engine is mounted on the wing or not. Every time the engine is mounted or dismounted, the sensor records this event.

The device according to the second embodiment operates as follows:

Essentially, the wireless communication unit 4 is activated only when the flight status is absent. The sensors and the measuring device detect the transportation status “Flight” or the transportation status “Ground”. When transportation status “Ground” is detected, the wireless communication unit can be activated and data can be transmitted to the data center. Commonly, data are transmitted once a day. It may also be provided that the data transmission takes place in response to a request from a data center sent in the form of an SMS message sent to the wireless communication unit of the device, for example.

At least in the transportation status “Flight” the measurements of the sensors, in particular the vibration, ultrasound signal, air pressure as well as flight altitude and temperature, are continuously logged.

The stored data log can be completely or partially included in the transmission of the position message to the data center. The operating hours of the engine can be easily obtained from the stored information about the transportation status “Flight”.

The control procedure of the device for the detection of the respective transportation status includes the following steps:

If the signal image of the vibration sensors exceeds a specific amplitude in at least one predefined frequency range, then the transportation status “Flight” is present and the wireless communication unit 4 cannot be activated.

If the vibration sensors do not indicate a flight status, additional checks will be performed in order to reliably verify “Ground” status and to exclude a flight status with shut-off engine:

At an air pressure corresponding to an altitude of more than 4,000 meters (about 13,000 ft.) the wireless communication unit will not be activated;

At an altitude of below 4,000 meters (about 13,000 ft.) information from the ultrasound sensor will be analyzed as well;

If the ultrasound signal is above a predefined threshold value, then the wireless communication unit will not be activated;

otherwise, the transportation status “Ground” will be detected, and the wireless communication unit can be activated.

After the wireless communication unit has been activated, it will automatically log into a base station of the wireless network.

In addition, module 1 is equipped with an internal power supply, so that the status can also be tracked without external power supply. This applies at least to the “off-wing” sensor. In doing so, the control procedure may provide that in case of the engine's dismounting, which will be detected by the “off-wing” sensor, the wireless communication unit will immediately send a corresponding status message to the data center. This is of particular interest in the case of leased engines in order to immediately detect any unauthorized manipulation, for example.

The respective special features of the first and the second embodiments are not limited to these samples but can be reasonably combined with each others, depending on the requirements. For example, the tracking of an engine according to the second embodiment may require a GPS receiver while in the first embodiment a GPS receiver might not be necessary.

What is claimed is:

1. An apparatus for the tracking of an object, comprising:
a wireless communication unit configured to transmit data via a wireless network;
a measuring device configured to detect a first transportation status of the object, wherein in the first transportation status, the object is located inside an aircraft or is in flight; and
a controller configured to control the wireless communication unit, the measuring device being connected to the controller.

2. The apparatus of claim 1, wherein the measuring device is configured to detect the first transportation status of the apparatus, wherein in the first transportation status, the apparatus is located inside an aircraft or is in flight.

3. The apparatus of claim 1, wherein the wireless communication unit is deactivated when the first transportation status is detected, so that in the first transportation status no radio signals are emitted by the wireless communication unit.

4. The apparatus of claim 1, wherein the wireless communication unit, the measuring device, and the controller are designed as an integrated module, the integrated module comprising an independent power supply.

5. The apparatus of claim 4, wherein the integrated module comprises an independent power supply.

6. The apparatus of claim 4, wherein the integrated module comprises a sensor, the sensor being connected to the measuring device.

7. The apparatus of claim 1, wherein the measuring device is connected to an altitude sensor.

8. The apparatus of claim 1, wherein the measuring device is connected to a motion sensor.

9. The apparatus of claim 1, wherein the measuring device is connected to at least one vibration sensor.

10. The apparatus of claim 1, wherein the measuring device is connected to at least one ultrasound sensor.

11. The apparatus of claim 1, further comprising:
a receiver configured for a global positioning system (GPS) and configured to receive a signal from the global positioning system.

12. The apparatus of claim 11, wherein the measuring device is configured to detect a strength of the signal from the global positioning system and configured to use the strength of the signal to identify the first transportation status.

13. The apparatus of claim 11, wherein the global positioning system determines information, the information comprising a momentary position, a speed of the object, or both.

14. The apparatus of claim 13, wherein the information is forwarded via the wireless communication unit.

15. The apparatus of claim 1, wherein an additional transportation status is detected via the measuring device, and wherein in the additional transportation status, the object is in motion and is not located inside the aircraft.

16. The apparatus of claim 1, wherein an additional transportation status is detected via the measuring device, and wherein in the additional transportation status, the object is not located inside an aircraft and is not in motion.

17. The apparatus of claim 1, wherein an absence of the first transportation status is detected only if at least two independent signals indicate the absence of the first transportation status.

18. The apparatus of claim 17, wherein the at least two independent signals are selected from a group consisting of a global positioning system (GPS) signal strength, a GPS-determined speed signal, a vibration signal, and an air pressure signal.

19. The apparatus of claim 1, wherein the wireless communication unit operates based on the Global System for Mobile communications (GSM) standard.

20. The apparatus of claim 1, wherein the apparatus is installed on cargo, the cargo being for transportation inside an aircraft.

21. The apparatus of claim 20, wherein the cargo comprises a United Load Device container.

22. The apparatus of claim 20, wherein the cargo comprises an engine shipping cradle.

23. The apparatus of claim 1, wherein the apparatus is installed on an aircraft engine.

24. A method for the control of an apparatus for the tracking of an object, the method comprising:
obtaining a first measured value with a measuring device;
comparing the first measured value with a first predefined threshold value; and
activating a wireless communication unit based on results of comparing the first measured value.

25. The method of claim 24, wherein the apparatus for the tracking of the object comprises:
the wireless communication unit, the wireless communication unit being configured to transmit data via a wireless network;
the measuring device, the measuring device being configured to detect a first transportation status of the object, wherein in the first transportation status, the object is located inside an aircraft or is in flight; and
a controller configured to control the wireless communication unit, the measuring device being connected to the controller.

26. The method of claim 24, further comprising:
deactivating the wireless communication unit during a standard mode.

27. The method of claim 26, wherein in the standard mode, obtaining and comparing are performed after a defined time window has expired.

28. The method of claim 24, wherein obtaining, comparing, and activating are performed in response to a sensor signal.

29. The method of claim 28, wherein the sensor signal comprises a motion sensor signal.

30. The method of claim 24, wherein the measured value comprises the signal strength of a received global positioning system (GPS) signal.

31. The method of claim 30, further comprising:
detecting a first transportation status of the object when an amplitude of the received GPS signal drops below the first predefined threshold value.

32. The method of claim 30, further comprising:
detecting a first transportation status of the object when the received GPS signal does not allow the detection of a speed of the object.

33. The method of claim 30, further comprising:
detecting a first transportation status of the object when a speed of the object determined via the received GPS signal is greater than the first predefined threshold value.

34. The method of claim 30, further comprising:
activating the wireless communication unit in a second transportation status; and
detecting the second transportation status only if a speed of the object determined via the the received GPS signal is below the first predefined threshold value, and the amplitude of the received GPS signal is below a second predefined threshold value.

35. The method of claim 34, further comprising:
activating the wireless communication unit in a third transportation status; and
detecting the third transportation status only if the speed of the object is at least close to zero.

36. The method of claim 24, wherein activating is performed only if the comparing the first measured value indicates an absence of a first transportation status for at least two times within a defined time period.

37. The method of claim 26, wherein the object is located by transmission of a wireless base station identifier.

38. The method of claim 24, wherein measured data measured by the measuring device are continuously logged in a log file, the measured data comprising the first measured value.

39. The method of claim 38, wherein the measured data comprise at least one of position, speed, air pressure, temperature, or vibration information.

40. The method of claim 24, further comprising:
automatically transmitting a message by the wireless communication unit when the object leaves a predefined geographical area.

41. The method of claim 24, further comprising:
transmitting data by the wireless communication unit in response to a request from a data center.

42. The method of claim 24, further comprising:
transmitting data by the wireless communication unit based on a predefined time schedule.
